(19) United States
(12) Patent Application Publication
(10) Pub. No.: US 2014/0106147 A1
(43) Pub. Date: Apr. 17, 2014

(54) PREPREG, COPPER CLAD LAMINATE, AND PRINTED CIRCUIT BOARD

(71) Applicant: SAMSUNG ELECTRO-MECHANICS CO., LTD., Suwon (KR)

(72) Inventors: Hyun Jun Lee, Suwon (KR); Seong Hyun Yoo, Suwon (KR); Jeong Kyu Lee, Suwon (KR); Jin Seok Moon, Suwon (KR); Keun Yong Lee, Suwon (KR)

(73) Assignee: SAMSUNG ELECTRO-MECHANICS CO., LTD., Suwon (KR)

(21) Appl. No.: 13/732,656

(22) Filed: Jan. 2, 2013

(30) Foreign Application Priority Data
Oct. 11, 2012 (KR) 10-2012-0112889

(51) Int. Cl. B32B 15/08

(52) U.S. Cl. CPC B32B 15/08
USPC 428/213; 442/180; 442/179; 442/164; 428/457; 524/602

(57) ABSTRACT

Disclosed herein is a prepreg including: a reinforcement substrate; and a polymer resin layer formed by impregnating a polymer resin containing a liquid crystal oligomer and an inorganic filler on the reinforcement substrate, wherein an impregnation ratio of the polymer resin is 60 to 85 wt., whereby a product manufactured by using the prepreg may have excellent coefficient of thermal expansion and thermal properties.

### CROSS REFERENCE TO RELATED APPLICATION

This application claims the benefit of Korean Patent Application No. 10-2012-0112889, filed on Oct. 11, 2012, entitled “Prepreg, Copper Clad Laminate, and Printed Circuit Board”, which is hereby incorporated by reference in its entirety into this application.

### BACKGROUND OF THE INVENTION

1. Technical Field

The present invention relates to a prepreg, a copper clad laminate, and a printed circuit board.

2. Description of the Related Art

Recently, the trend for multifunctional and high-speed electronic products has progressed at a rapid speed. In order to follow the trend, a semiconductor chip has rapidly developed. The semiconductor chip has developed at a speed that surpasses Moore's law that an amount of a data that may be stored in the semiconductor chip increases twice every 18 months. Therefore, a semiconductor mounted substrate connecting the semiconductor chip to a main board has been rapidly developed. A high-speed and a high integration of the semiconductor mounted substrate are requested for developing the semiconductor mounted substrate. In order to meet the requirements, the semiconductor mounted substrate is requested to be improve and developed, that is, to be light and slim, and have a fine circuit, excellent electrical properties, high reliability, high-speed signal transfer structure, or the like.

In particular, in a substrate material, the demand for implementing a multi-layered substrate has increased in order to miniaturize the complete products. In manufacturing a multilayered and thin substrate, defects in the semiconductor mounted substrate such as a solder joint defect, and the like, has increased due to warpage deformation generated by a difference in coefficient of thermal expansion between the board and a silicon, and a variety of technologies have been developed in order to solve the problem. In order to achieve high integration and high speed of the semiconductor mounted substrate, an improvement in insulation materials such as a copper clad laminate (CCL), a prepreg, and the like, which is a core material of the semiconductor mounted substrate, needs to have priority.

In order to solve the above-described problems, Patent Document 1 discloses a substrate material having a low coefficient of thermal expansion in order to decrease warpage deformation generated due to a difference in the coefficient of thermal expansion. However, as disclosed in Patent Document 1, in the case of manufacturing a prepreg and a copper clad laminate using an impregnation ratio of 44 to 52 wt. % of a liquid crystal polymer resin impregnated in a reinforcement substrate, the coefficient of thermal expansion is 10 ppm/° C. or more, which is not appropriate for a material of a thinner and multi-layered substrate.

(Patent Document 1) Korean Patent Laid-Open Publication No. KR 2009-0049444

### SUMMARY OF THE INVENTION

The present inventors found that a product manufactured by including a polymer resin layer having a range of an appropriate thickness formed on a surface of a substrate produced by using a liquid crystal polymer resin and an optimized resin impregnation ratio had a low coefficient of thermal expansion and excellent thermal properties, and based on this, completed the present invention.

Therefore, the present invention has been made in an effort to provide a prepreg having a low coefficient of thermal expansion and an increased glass transition temperature.

In addition, the present invention has been made in an effort to provide a copper clad laminate having a low coefficient of thermal expansion and an increased glass transition temperature by including the prepreg.

Further, the present invention has been made in an effort to provide a printed circuit board including the prepreg.

According to a preferred embodiment of the present invention, there is provided a prepreg including: a reinforcement substrate; and a polymer resin layer formed by impregnating a polymer resin containing a liquid crystal oligomer and an inorganic filler on the reinforcement substrate, wherein an impregnation ratio of the polymer resin is 60 to 85 wt. % based on the sum of weight of the reinforcement substrate and weight of the polymer resin.

The inorganic filler may have an amount of 250 to 700 parts by weight based on 100 parts by weight of the liquid crystal oligomer.

The liquid crystal oligomer may be represented by Chemical Formula 1, Chemical Formula 2, Chemical Formula 3, or Chemical Formula 4 below:

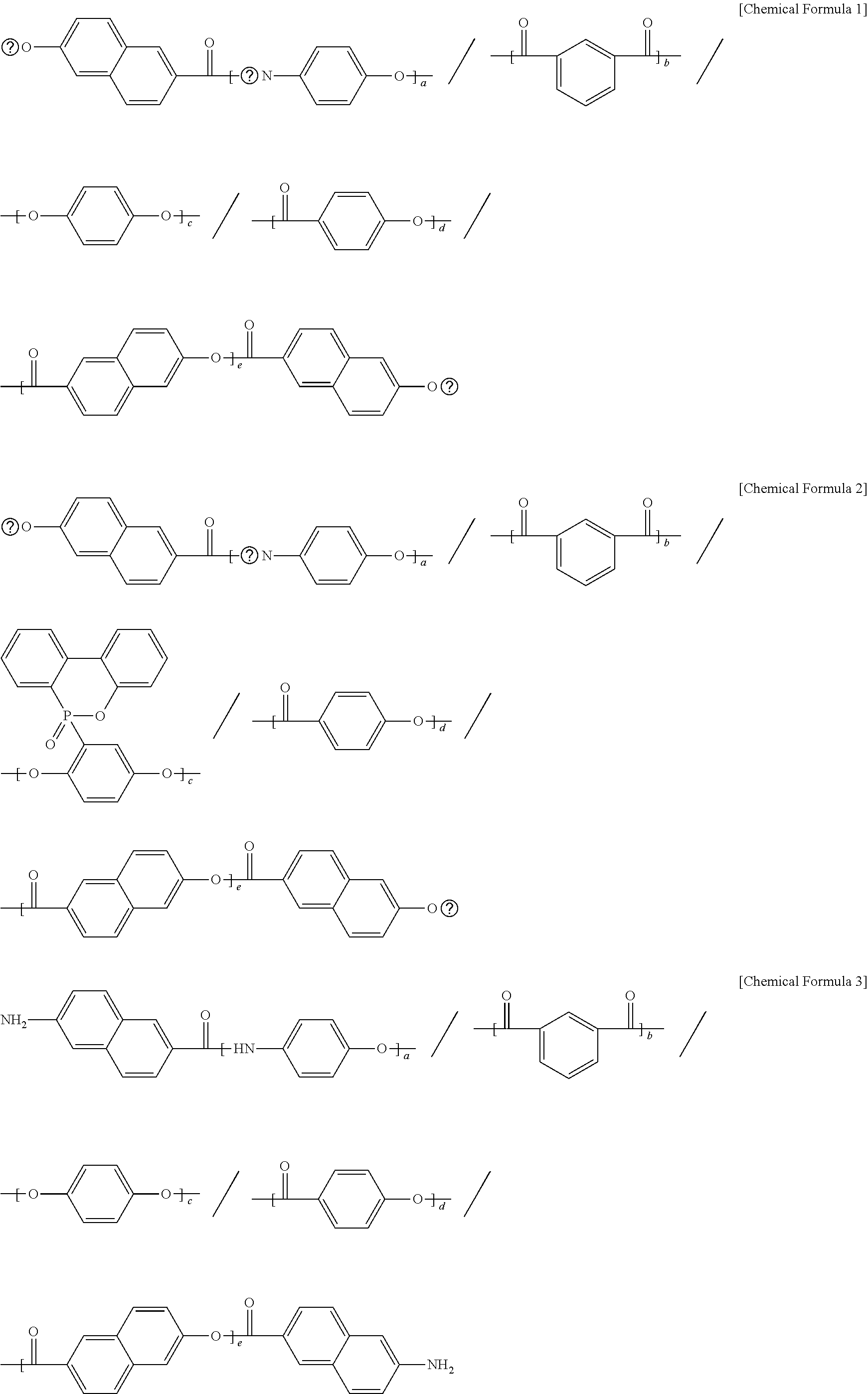

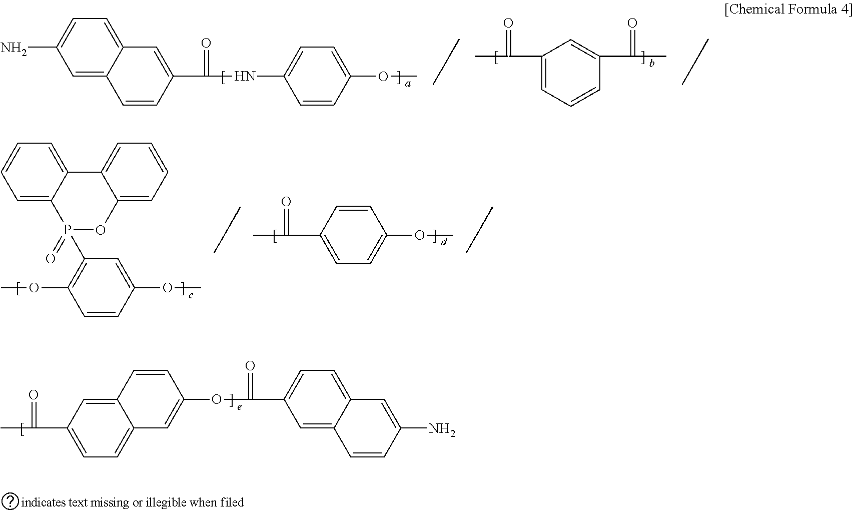

(In Chemical Formulas 1 to 4, a is an integer of 13 to 26, b is an integer of 13 to 26, c is an integer of 9 to 21, d is an integer of 10 to 30, and e is an integer of 10 to 30).

The reinforcement substrate may be one and more selected from a group consisting of a glass fiber fabric, a glass fiber non-woven fabric, a carbon fiber fabric, and an organic polymer fiber fabric.

The inorganic filler may be one and more selected from a group consisting of silica, alumina, barium sulfate, talc, clay, a mica powder, aluminum hydroxide, magnesium hydroxide, calcium carbonate, magnesium carbonate, magnesium oxide, boron nitride, boron aluminum, barium titanate, calcium titanate, magnesium titanate, bismuth titanate, titanium oxide, barium zirconate, and calcium zirconate.

The polymer resin may include one and more hardeners selected from a group consisting of an amide-based hardener, a polyamine-based hardener, an acid anhydride hardener, a phenol novolac type hardener, a polymercaptan hardener, a tertiary amine hardener, and an imidazole hardener.

A thickness ratio of the polymer resin layer may be 9 to 23% based on the sum of a thickness of the reinforcement substrate and a thickness of the polymer resin layer.

According to another preferred embodiment of the present invention, there is provided a copper clad laminate including: a prepreg laminate having at least one prepreg as described above laminated therein; and a copper thin film laminated on one surface or both surfaces of the prepreg laminate.

An adhesion strength between the prepreg and the copper thin film adhered thereto may be 0.5 to 2.5N/mm.

According to still another preferred embodiment of the present invention, there is provided a printed circuit board comprising the copper clad laminate as described above.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a partially perspective view showing a prepreg according to a preferred embodiment of the present invention;

FIG. 2 is a cross-sectional view showing a copper clad laminate having the prepreg of FIG. 1; and

FIG. 3 is a cross-sectional view showing a printed circuit board having the prepreg of FIG. 1.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

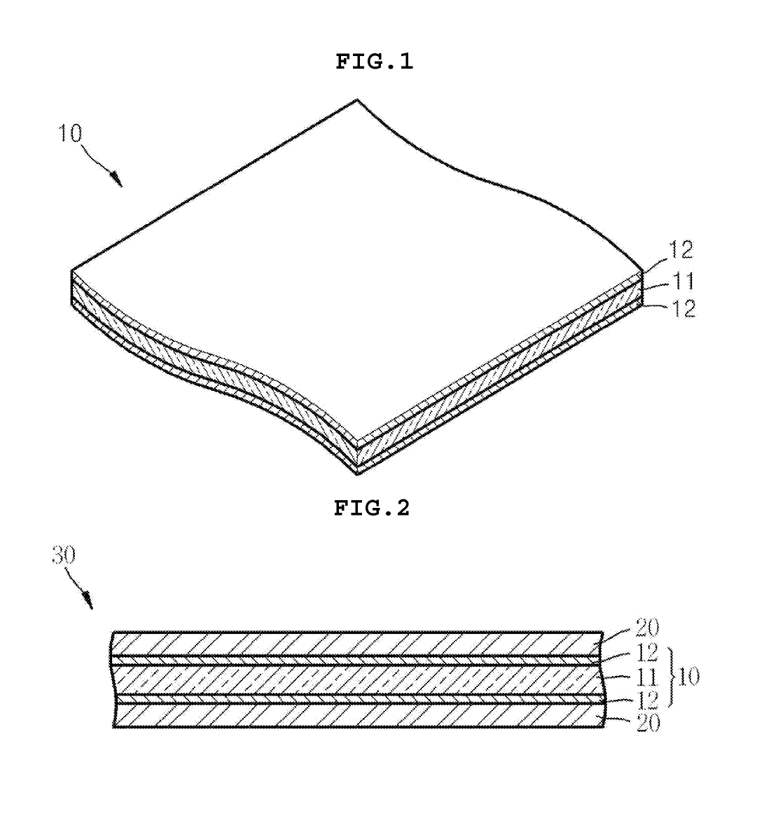

FIG. 1 is a partially perspective view showing a prepreg according to a preferred embodiment of the present invention. Referring to FIG. 1, the prepreg 10 includes a reinforcement substrate 11 and a polymer resin layer 12. In addition, although not shown by a division, the reinforcement substrate 11 includes the polymer resin impregnated therein, and some of the polymer resin is exuded on a surface of the reinforcement substrate to form the polymer resin layer 12.

As the reinforcement substrate 11, a glass fiber fabric, a glass fiber non-woven fabric, a carbon fiber fabric, or an organic polymer fiber fabric may be used. A composition of the glass fiber is determined by considering required properties (mechanical property, thermal property, electrical insulation property, dielectric property, and the like), solubility, radioactivity, easiness of obtaining a raw material, economic efficiency, or the like, at the time of using it As a raw material of a printed circuit board, an E-glass fiber, which is balanced in view of efficiency and cost, has been generally used. In addition to the E-glass fiber, T-glass (or S-glass) fiber which is in a low thermal expansion and high elasticity type, having a high SiO₂ ratio, or an NE-glass fiber which is a low k-dielectric constant type have been developed and used as a specific glass composition. As an organic polymer fiber, an aramid resin, a crystal liquid polyester resin, polyphenylene sulfide (PPS), polyether ether ketone (PEEK), polyphthal amide (PPA), polysulfone (PSU), polyether imide (PEI), polyether sulfone (PES), polyphenyl sulfone (PPSU), polyamide imide (PAI), or the like, may be used.

In order to increase an adhesion with the resin, the reinforcement substrate 11 may be subjected to treatments known in the art, such as a silane coupling agent treatment, a plasma treatment, a corona treatment, various chemical treatments, a blast treatment, and the like, on a surface thereof.

In addition, a thickness of the reinforcement substrate 11 is not particularly limited; however, for example, it is 4 to 200 μm, and is preferably 10 to 150 μm.

The polymer resin layer 12 is formed by impregnating the polymer resin containing the liquid crystal oligomer and the inorganic filler in the reinforcement substrate 11.

The liquid crystal oligomer may be used without limitation as far as it is soluble in a solvent; however, in a preferred embodiment in the present invention, the liquid crystal oligomers represented by Chemical Formulas 1 to 4 below are used

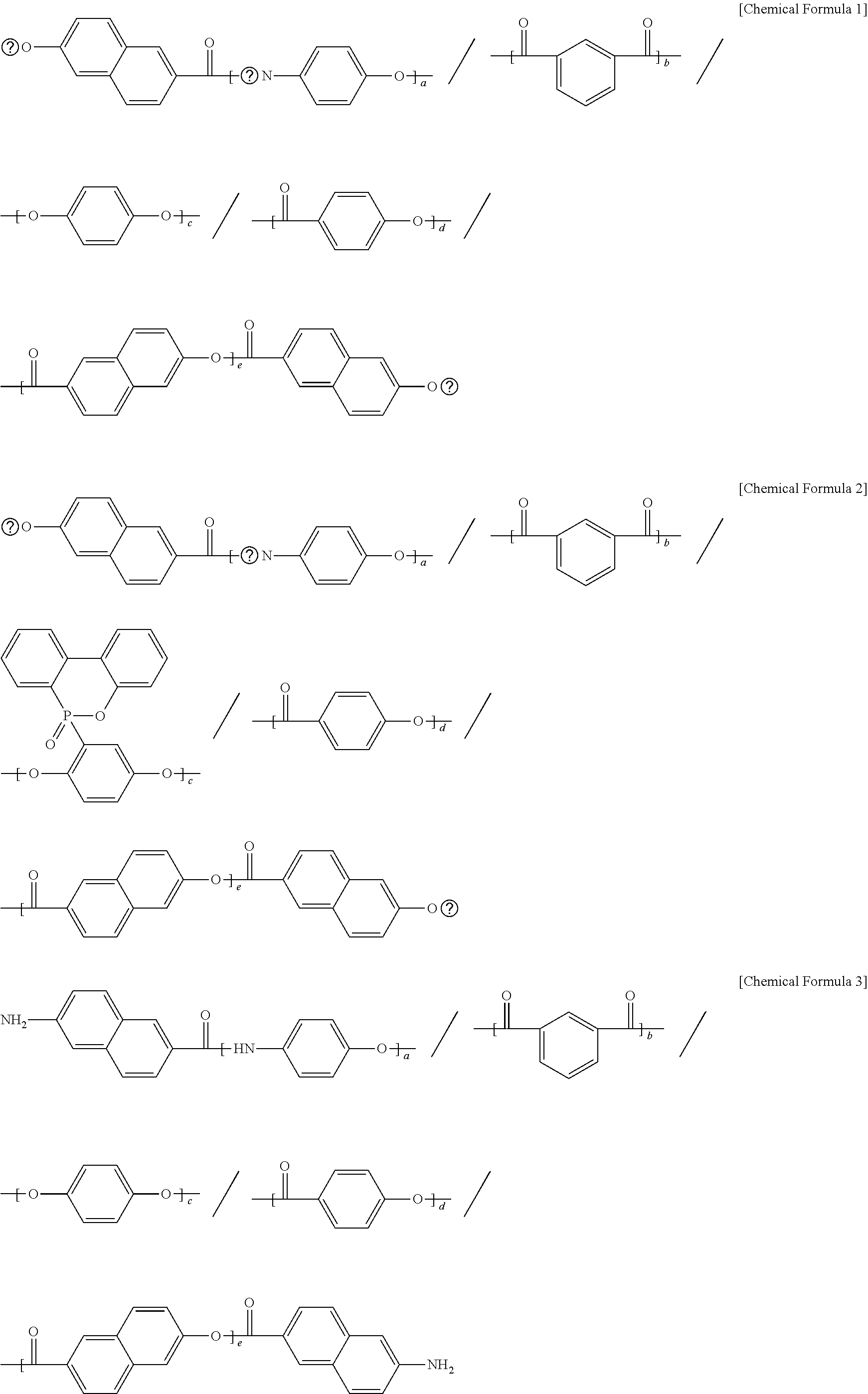

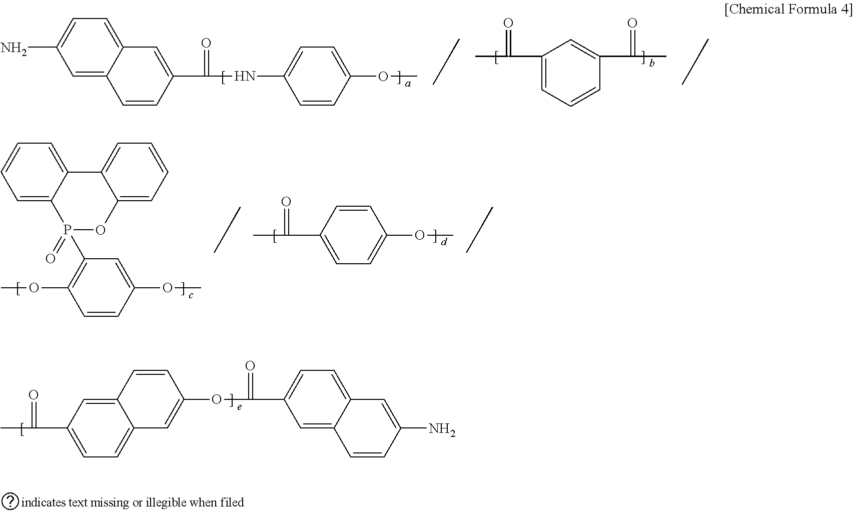

In Chemical Formulas 1 to 4, a is an integer of 13 to 26; b is an integer of 13 to 26; c is an integer of 9 to 21; d is an integer of 10 to 30; and e is an integer of 10 to 30.

The liquid crystal oligomer represented by Chemical Formulas 1 to 4 above may contain ester groups at both ends of a main chain in order to improve the dielectric dissipation factor and the dielectric constant; contain a naphthalene group for crystallinity; and contain a phosphorous component imparting flame retardancy.

The liquid crystal oligomer has a number average molecular weight of, preferably, 2,500 to 6,500 g/mol, and more preferably, 3,000 to 6,000 g/mol, and much more preferably. If the number average molecular weight of the liquid crystal oligomer is below 2,500 g/mol, mechanical properties may be deteriorated. If the number average molecular weight thereof is above 6,500 g/mol, solubility may be deteriorated.

As a solvent dissolving the liquid crystal oligomer, a non-halogen solvent is preferably used. However, the present invention is not limited thereto, a polar non-proton based compound, halogenated phenol, o-dichlorobenzene, chloroform, methylene chloride, tetrachloroethane, or the like may be used alone or in combination of two or more thereof In particular, in the case of using the liquid crystal oligomer well-dissolved even in the non-halogen solvent, since the solvent containing halogen atoms does not need to be used, a metal thin film of a metal laminate or a printed wiring board containing the solvent may be previously prevented from being corroded due to a halogen atom as the case where a solvent containing the halogen atoms is used.

At the time of producing the prepreg 10 according to the present invention, time at which the polymer resin solution prepared by dissolving the liquid crystal oligomer into the solvent is impregnated in the reinforcement substrate may be 0.02 to 10 min. In the case where the impregnation time is less than 0.02 min, the polymer resin may be uniformly impregnated in the reinforcement substrate, and in the case where the time is more than 10 min, productivity may be deteriorated. In addition, a temperature at which the polymer resin solution prepared by dissolving the liquid crystal oligomer into the solvent is impregnated in the reinforcement substrate may be 20 to 190° C., and a mom temperature is preferable.

Further, a ratio (that is, an impregnation ratio) at which the polymer resin is impregnated in the reinforcement substrate 11 is 60 to 85 wt. % based on the sum of weight of the reinforcement substrate 11 and weight of the polymer resin. In the case where the impregnation ratio is less than 60 wt. %, an amount of polymer resin impregnated in the reinforcement substrate 11 is not sufficient, such that the polymer resin layer 12 is not formed in a sufficient thickness. Therefore, at the time of laminating copper thin films 20 as described below, the reinforcement substrate 11 and copper thin film 20 directly contact to each other without an adhesive medium layer, or contact via the excessively thinned polymer resin layer 12, such that an adhesive strength between them is deteriorated, which is not preferable. Accordingly, the copper thin film 20 is also easily migrated on a surface of the substrate. On the other hand, in the case where the impregnation ratio is more than 85 wt. %, the thickness of the polymer resin layer 12 is formed to be excessively thick, such that a crack occurs on the polymer resin layer 12, and therefore, the adhesive strength between the reinforcement substrate 11 and the copper thin film 20 is deteriorated, which is not preferable. When considering a thickness ratio, a range of an appropriate thickness of the polymer resin layer 12 formed as described above is preferably 9 to 23% based on the sum of a thickness of the reinforcement substrate 11 and a thickness of the polymer resin layer 12.

To a composition solution dissolving the liquid crystal polymer into the solvent, an inorganic filler such as a silica, aluminum hydroxide, calcium carbonate, and an organic filler such as a hardening epoxy, a cross-linked acryl, or the like, may be added in order to control a dielectric constant and coefficient of thermal expansion within a range at which purposes of the present invention are maintained.

Specific examples of the inorganic filler used in the present invention may include silica, alumina, barium sulfate, talc, clay, a mica powder, aluminum hydroxide, magnesium hydroxide, calcium carbonate, magnesium carbonate, magnesium oxide, boron nitride, aluminum borate, barium titanate, calcium titanate, magnesium titanate, bismuth titanate, titan oxide, barium zirconate, calcium zirconate, and the like, which are used alone or in combination of two or more thereof Particularly, silica having a low dielectric dissipation factor is preferable.

In addition, if the inorganic filler has an average particle size of 5 μm or larger, since it is difficult to form a fine pattern stably when a circuit pattern is formed in a conductor layer, the average particle size of the inorganic filler may be 5 μm or less. Further, the inorganic filler may be surface-treated with a surface treating agent such as a silane coupling agent, in order to improve a moisture resistance. A silica having a diameter of 0.2 to 2 μm is more preferable.

It is preferable that an amount of the inorganic filler or the organic filler is added in a ratio of 250 to 700 parts by weight based on 100 parts by weight of the liquid crystal oligomer. In the case where the added amount of the inorganic filler or the organic filler is less than 250 parts by weight, the thickness of the polymer resin layer tends to be excessively thick in view of the impregnation ratio, and in the case where the added amount thereof is more than 700 parts by weight, an effect of the liquid crystal oligomer as a binder is decreased.

The prepreg 10 is produced by impregnating the composition solution dissolving the liquid crystal polymer into the solvent in the substrate, or coating the composition solution on the substrate, and then performing drying and rolling processes. The drying and rolling processes may be sequentially performed, or simultaneously performed. By the drying process, the solvent contained in the prepreg 10 is removed, and by the rolling process, the prepreg 10 has a desired thickness. The rolling process may be performed under a condition in which rolling roll pressure is 10 kgf/cm², a rolling roll temperature is 120° C., and a temperature of a prepreg is 300° C.. In addition, a method of removing the solvent is not particularly limited; however, solvent evaporation is preferable. For example, evaporation by heating, decompression, ventilation, or the like, may be performed. Among them, when considering applicability to production process of the existing prepreg, production efficiency, and handling, solvent evaporation by heating is preferable, and the solvent evaporation by a ventilation-heating is more preferable.

At the time of removing the solvent, it is preferable that the composition solvent of the liquid crystal polymer is pre-dried at a heating temperature of 20 to 190° C. for 1 to 10 min, and heat treatment is then performed in a range of 190 to 350° C. for 1 min to 10 hours.

The prepreg 10 obtained by the present invention includes the polymer resin layer 12 having an appropriate thickness as described above on one surface or both surfaces thereof. Specifically, some of the liquid crystal polymer resin impregnated in the reinforcement substrate 11 is exuded on a surface of the reinforcement substrate 11 at the time of rolling process to form the liquid crystal polymer resin layer 12. As such, the prepreg 10 includes the polymer resin layer 12 which functions as a adhesion medium, such that the adhesive strength between the prepreg 10 and the metal thin film 20 is increased. Due to an increase in the adhesive strength, even in the case where the metal thin film is heat-expanded by a high temperature treatment during the subsequent process of the printed circuit board, a thermal deformation phenomenon such as peeling the metal thin film from a surface of the prepreg 10 may be prevented from being generated.

In addition, in the prepreg 10, a thickness is preferably about 5 to 200 μm, and more preferably, about 30 to 150 μm, and a relative dielectric constant is preferably 4.0 or less. In the case where the relative dielectric constant is more than 4.0, the prepreg is not appropriate as an insulating substrate at a high frequency region, which is not preferable.

Since the prepreg 10 according to the present invention uses the liquid crystal polymer resin having low moisture absorption and low dielectric property and an organic or inorganic fiber woven fabric and/or non-woven fabric having excellent mechanical strength, dimensional stability is excellent, thermal deformation is less generated and hard, which is advantageous for a via hole drilling process and a laminating process.

In addition, a prepreg laminate may be manufactured by laminating a predetermined number of prepregs 10, heating, and applying pressure thereto.

FIG. 2 is a cross-sectional view showing a preferred embodiment of the copper clad laminate 30 having the prepreg 10 of FIG. 1. The same reference numerals as those of the previous drawings indicate the same components as those of the previous drawings.

The copper clad laminate 30 according to the preferred embodiment of the present invention includes the prepreg 10 and the copper thin film 20 disposed on both surfaces thereof. In addition, the prepreg 10 includes the reinforcement substrate 11, the polymer resin (not shown) impregnated therein, and the polymer resin layer 12 formed by exuding some of the polymer resin on a surface of the reinforcement substrate 11. Since the appropriate thickness and the functional effect of the polymer resin layer 12 are the same as described above, a detailed description thereof will be omitted.

As described above, the impregnation ratio of the polymer resin may be controlled to obtain the polymer resin layer 12 within a range of an appropriate thickness, and the polymer resin layer 12 may function as an adhesive medium to have the adhesive strength between the prepreg 10 and the copper thin film 20 adhered thereto of a numerical range of 0.5 to 2.5N/mm. In the case where the adhesive strength is less than 0.5N/mm, deformation occurs by thermal and mechanical external force at the time of processing the printed circuit board to generate a peeling phenomenon of the copper thin film 20, which is not preferable. In the case where the adhesive strength is more than 2.5N/mm, time required for etching and stripping processes is largely consumed, which is not preferable.

The copper clad laminate 30 may be manufactured by disposing the copper thin film 20 on one surface or both surfaces of the prepreg 10 or the prepreg laminate (not shown) in which the predetermined number of prepregs are laminated, heating the entire prepreg or the prepreg laminate, and applying pressure thereto. In the copper clad laminate 30, each thickness of the prepreg 10 or the prepreg laminate and the copper thin film 20 is not particularly limited; however, each thickness is preferably 30 to 200 μm, and 1 to 50 μm. In the case where the thickness of the prepreg 10 or the prepreg laminate is less than 30 μm, the prepreg 10 or the prepreg laminate may be easily broken due to insufficient strength at the time of the winding process, which is not preferable. In the case where the thickness thereof is more than 200 μm, there is a limitation in the laminated number of laminates having a limited thickness, which is not preferable. In the case where the thickness of the copper thin film 20 is less than 1 μm, the copper thin film may easily broken at the time of laminating the copper thin films, which is not preferable, and in the case where the thickness thereof is more than 50 μm, this thickness may be unfavorable in laminating a multi-layered laminate, which is not preferable.

The heating and pressurizing processes applied at the time of manufacturing the copper clad laminate 30 are preferably performed at a temperature ranging from 250 to 400° C., and pressure of 5 to 100 Kgfcm2; however, since they may be appropriately determined by considering properties of the prepreg 10, reactivity with the polymer resin composition, capability of a press machine, a desired thickness of the copper clad laminate 30, or the like, the present invention is not limited thereto.

In addition, the copper clad laminate 30 according to the preferred embodiment of the present invention is not additionally required to have an adhesive layer interposed between the prepreg or the prepreg laminate and the metal thin film in order to provide the adhesive strength therebetween. Therefore, a manufacturing process may be simplified and manufacturing cost thereof may be reduced.

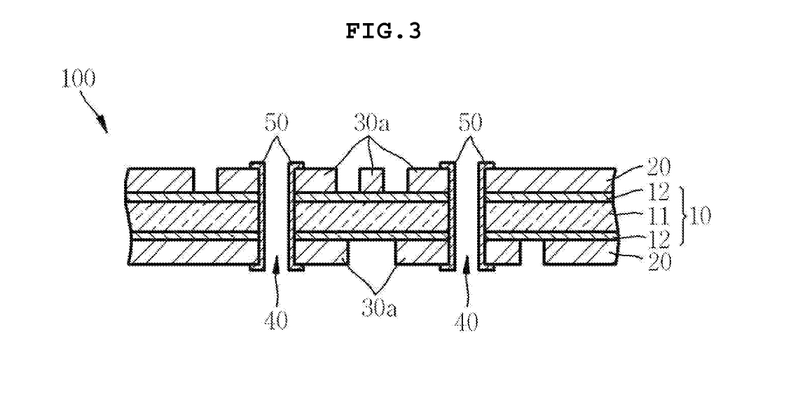

FIG. 3 is a cross-sectional view showing a preferred embodiment of the printed circuit board 100 having the prepreg 10 of FIG. 1. The same reference numerals as those of the previous drawings indicate the same components as those of the previous drawings.

The printed circuit board 100 according to the present invention includes the substrate 11, the liquid crystal polymer resin impregnated therein, the prepreg 10 having the liquid crystal polymer resin layer 12, and the copper thin film 20. The printed circuit board 100 may be manufactured by positioning the copper thin film 20 on both surfaces of the prepreg 10, heating, applying pressure thereinto, and forming a circuit 30a on the copper thin film 20. The circuit may be formed by known methods of the related art such as a subtractive method, and the like. In addition, a through hole 40 penetrating the prepreg 10 and the copper thin film 20 is formed in the printed circuit board 100, and a metal plating layer 50 is applied to an inner wall of the through hole 40. In addition, a predetermined circuit component (not shown) is generally mounted on the printed circuit board 100.

Hereinafter, the present invention will be described in more detail with reference to the following examples and comparative examples; however, it is not limited thereto.

### PREPARATION EXAMPLE 1

Preparation of Liquid Crystal Oligomer

218.26 g (2.0 mol) of 4-aminophenol, 415.33 g (2.5 mol) of isophthalic acid, 276.24 g (2.0 mol) of 4-hydroxybenzoic acid, 282.27 g (1.5 mol) of 6-hydroxy-2-naphthoic acid, 648.54 g (2.0 mol) of 9,10-dihydroxy-9-oxa-10-phosphaphenanthrene-10-oxide(DOPO), 1531.35 g (15.0 mol) of acetic anhydride were added to a 20 L glass reactor. After the inside of the reactor was sufficiently substituted using nitrogen gas, a temperature in the reactor was increased to 230° C. under a nitrogen gas flow, and a reflux was performed for 4 hours while maintaining the temperature in the reactor at 230° C. After 188.18 g (1.0 mol) of an end-capped 6-hydroxy-2-naphthoic acid was further added thereto, the acetic acid, which is a reaction byproduct, and unreacted acetic acid anhydride were removed to obtain a liquid crystal oligomer represented by Chemical Formula 3 as shown above, having a molecular weight of about 4500.

### EXAMPLE 1

Production of Prepreg

33.0 g of the liquid crystal oligomer obtained by preparation example 1, 22.0 g of Araldite MY-721 (Huntsmann International LLC) as an epoxy resin, and 0.22 g of dicyandiamide (DICY) as a curing catalyst were added to 45.0 g of N,N′-dimethylacetamide (DMAc) to prepare a mixture solution. 82.5 g of a silica filler (Admatech Co. Ltd.) was mixed with the mixture solution to prepare a slurry. The slurry is uniformly impregnated in the glass fiber (1078, Baotek INC.). The glass fiber having the slurry impregnated therein was passed through a heating zone of 200° C., followed by semi-hardening, to obtain a prepreg. Here, a polymer weight based on the overall weight of the prepreg, that is, an impregnation ratio was 63.9 wt. %. The prepreg was hardened by a vacuum press under a condition of a pressure of 2.3 Mpa and a temperature of 230° C. for 2 hours and properties thereof were evaluated.

### EXAMPLE 2

Production of Prepreg

33.0 g of the liquid crystal oligomer obtained by preparation example 1, 22.0 g of Araldite MY-721 (Huntsmann International LLC) as an epoxy resin, and 0.22 g of dicyandiamide (DICY) as a curing catalyst were added to 45.0 g of N,N′-dimethylacetamide (DMAc) to prepare a mixture solution. 128.3 g of a silica filler (Admatech Co., Ltd.) was mixed with the mixture solution to prepare a slurry. The slurry is uniformly impregnated in the glass fiber (1078, Baotek INC.). The glass fiber having the slurry impregnated therein was pass through a heating zone of 200° C., followed by semi-hardening, to obtain a prepreg. Here, a polymer weight based on the overall weight of the prepreg, that is, an impregnation ratio was 67.3 wt. %. The prepreg was hardened at a vacuum press under a condition of a pressure of 2.3 Mpa and a temperature of 230° C. for 2 hours and properties thereof were evaluated.

### COMPARATIVE EXAMPLE 1

33.0 g of the liquid crystal oligomer obtained by preparation example 1, 22.0 g of Araldite MY-721 (Huntsmann International LLC) as an epoxy resin, and 0.22 g of dicyandiamide (DICY) as a curing catalyst were added to 45.0 g of N,N′-dimethylacetamide (DMAc) to prepare a mixture solution. The mixture solution is uniformly impregnated in the glass fiber (1078, Baotek INC.). The glass fiber having the mixture solution impregnated therein was passed through a heating zone of 200° C., followed by semi-hardening, to obtain a prepreg. Here, a polymer weight based on the overall weight of the prepreg, that is, an impregnation ratio was 50 wt. %. The prepreg was hardened by a vacuum press under a condition of a pressure of 2.3 Mpa and a temperature of 230° C. for 2 hours and properties thereof were evaluated.

### COMPARATIVE EXAMPLE 2

33.0 g of the liquid crystal oligomer obtained by preparation example 1, 22.0 g of Araldite MY-721 (Huntsmann International LLC) as an epoxy resin, and 0.22 g of dicyandiamide (DICY) as a curing catalyst were added to 45.0 g of N,N′-dimethylacetamide (DMAc) to prepare a mixture solution. 55 g of a silica filler (Admatech Co., Ltd.) was mixed with the mixture solution to prepare a slurry. The slurry is uniformly impregnated in the glass fiber (1078, Baotek INC.). The glass fiber having the slurry impregnated therein was passed through a heating zone of 200° C., followed by semi-hardening, to obtain a prepreg. Here, a polymer weight based on the overall weight of the prepreg, that is, an impregnation ratio was 51.5 wt. %. The prepreg was hardened by a vacuum press under a condition of a pressure of 2.3 Mpa and a temperature of 230° C. for 2 hours and properties thereof were evaluated.

Evaluation on Thermal Property

The glass transition temperatures (Tg) of each sample of the prepregs produced according to examples 1 and 2 and comparative examples 1 and 2 were measured by using dynamic mechanical analyzer (DMA: TA Instruments DMA Q800). The coefficient of thermal expansion (CIE) was measured by thermomechanical analyzer (TMA, TA Instruments TMA Q400) in a nitrogen atmosphere while the temperature was increased at a rate of 10° C./min. The results thereof are shown in the following Table 1.

TABLE 1

| | | | Comparative | Comparative |
|---|---|---|---|---|
| | Example 1 | Example 2 | Example 1 | Example 2 |
| Glass Transition | 246 | 249 | 235 | 240 |
| Temperature (° C.) | | | | |
| Coefficient of | 9 | 7 | 13 | 11 |
| Thermal Expansion | | | | |
| (ppm/° C.) | | | | |

It may be appreciated from Table 1 above that the prepregs produced according to examples 1 and 2 having increased impregnation ratio of the liquid crystal polymer resin by increasing the amount of the silica filler as the inorganic filler had a lower coefficient of thermal expansion (CIE), and a higher glass transition temperature (Tg) as compared to the prepregs produced according to comparative examples 1 and 2.

As set forth above, the prepreg according to the preferred embodiment of the present invention may include the liquid crystal polymer resin layer having a range of an appropriate thickness formed on the surface of the substrate by using the liquid crystal polymer resin and the optimized resin impregnation ratio to thereby have low coefficient of thermal expansion, excellent heat-resistance, and increased glass transition temperature.

In addition, the copper clad laminate and the printed circuit board according to the preferred embodiment of the present invention may have low thermal expansion, increased glass transition temperature, high rigidity, heat-resistance, and mechanical strength, by using the prepreg.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A prepreg comprising:
a reinforcement substrate; and
a polymer resin layer formed by impregnating a polymer resin containing a liquid crystal oligomer and an inorganic filler on the reinforcement substrate,
wherein an impregnation ratio of the polymer resin is 60 to 85 wt. % based on the sum of weight of the reinforcement substrate and weight of the polymer resin.

2. The prepreg as set forth in claim 1, wherein the inorganic filler has an amount of 250 to 700 parts by weight based on 100 parts by weight of the liquid crystal oligomer.

3. The prepreg as set forth in claim 1, wherein the liquid crystal oligomer is represented by Chemical Formula 1, Chemical Formula 2, Chemical Formula 3, or Chemical Formula 4 below: 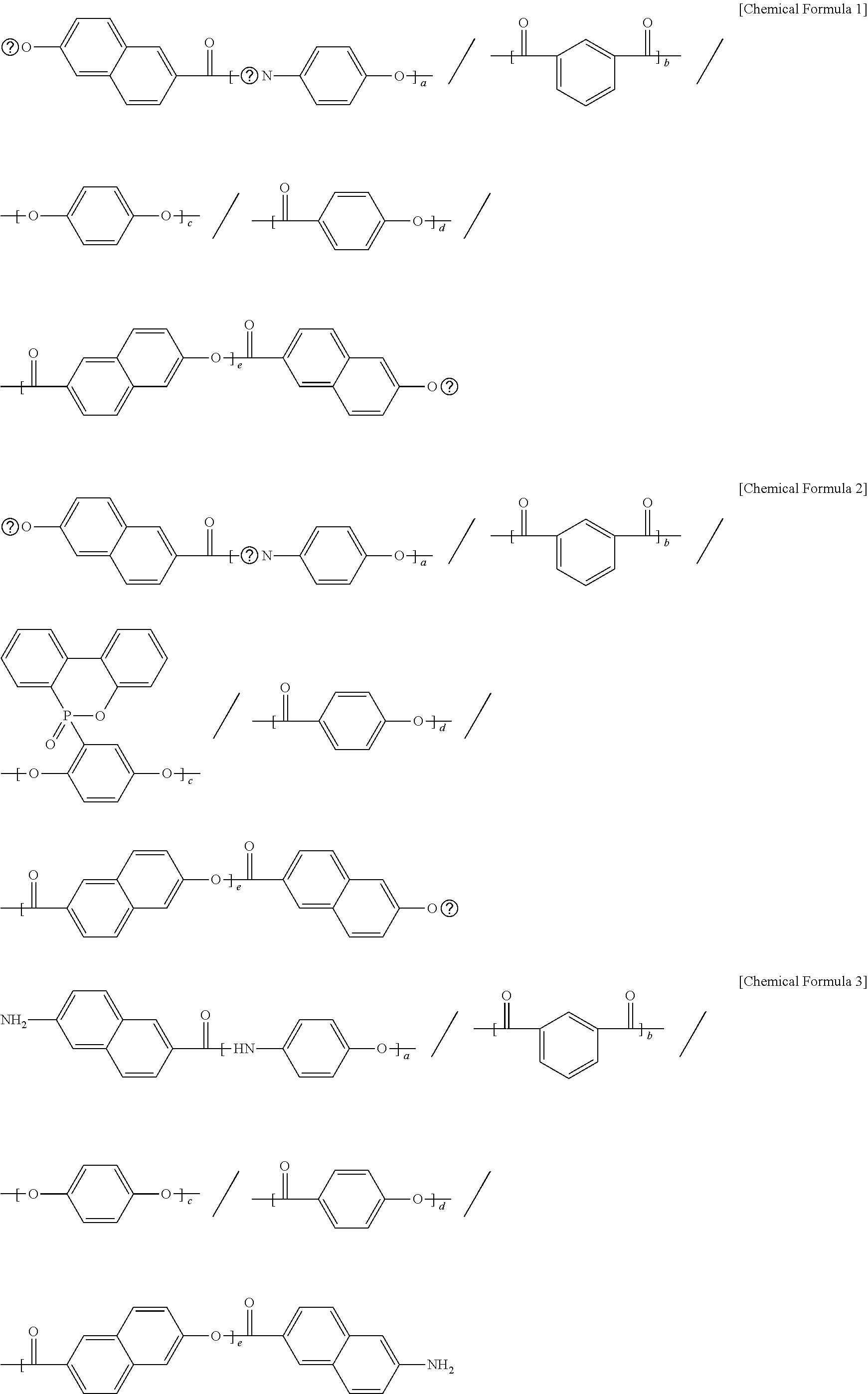 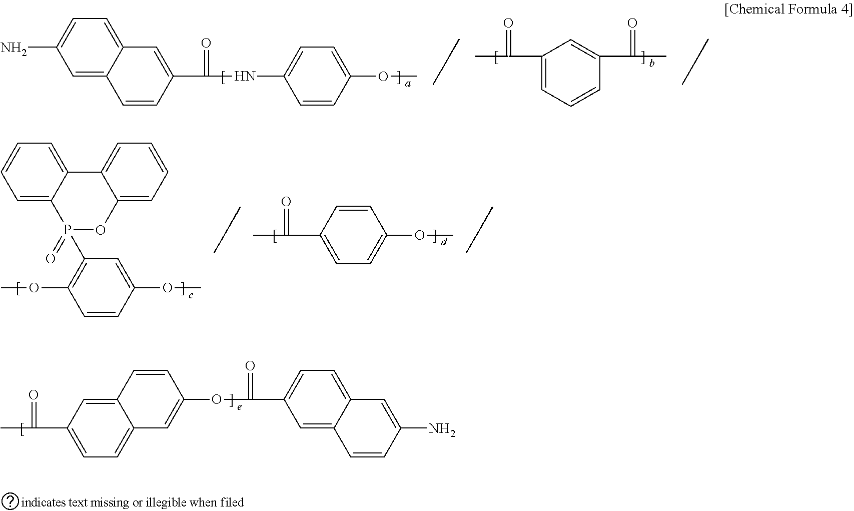
(In Chemical Formulas 1 to 4, a is an integer of 13 to 26, b is an integer of 13 to 26, c is an integer of 9 to 21, d is an integer of 10 to 30, and e is an integer of 10 to 30).

4. The prepreg as set forth in claim 1, wherein the reinforcement substrate is one and more selected from a group consisting of a glass fiber fabric, a glass fiber non-woven fabric, a carbon fiber fabric, and an organic polymer fiber fabric.

5. The prepreg as set forth in claim 1, wherein the inorganic filler is one and more selected from a group consisting of silica, alumina, barium sulfate, talc, clay, a mica powder, aluminum hydroxide, magnesium hydroxide, calcium carbonate, magnesium carbonate, magnesium oxide, boron nitride, boron aluminum, barium titanate, calcium titanate, magnesium titanate, bismuth titanate, titanium oxide, barium zirconate, and calcium zirconate.

6. The prepreg as set forth in claim 1, wherein the polymer resin includes one and more hardeners selected from a group consisting of an amide-based hardener, a polyamine-based hardener, an acid anhydride hardener, a phenol novolac type hardener, a polymercaptan hardener, a tertiary amine hardener, and an imidazole hardener.

7. The prepreg as set forth in claim 1, wherein a thickness ratio of the polymer resin layer is 9 to 23% based on the sum of a thickness of the reinforcement substrate and a thickness of the polymer resin layer.

8. A copper clad laminate comprising:
a prepreg laminate having at least one prepreg as set forth in claim 1 laminated therein; and
a copper thin film laminated on one surface or both surfaces of the prepreg laminate.

9. The copper clad laminate as set forth in claim 8, wherein an adhesion strength between the prepreg and the copper thin film adhered thereto is 0.5 to 2.5 N/mm.

10. A printed circuit board comprising the copper clad laminate as set forth in claim 8.
